(19) United States
(12) Patent Application Publication
(10) Pub. No.: US 2012/0097003 A1
(43) Pub. Date: Apr. 26, 2012

(54) ROTARY TYPE FEEDING DEVICE FOR A WOODWORKING MACHINE

(76) Inventor: Chin-Chi Lin, Houli Township (TW)

(21) Appl. No.: 12/910,206

(22) Filed: Oct. 22, 2010

(51) Int. Cl. B27B 25/00

(52) U.S. Cl. 83/419

(57) ABSTRACT

A rotary type feeding device for a woodworking machine includes a support post unit, a cantilever unit, and a feeding wheel unit. The support post unit includes a base fixed on a worktable, and an upright pivot shaft fixed on the base. The cantilever unit includes a cantilever rotatable about the pivot shaft, and a return member disposed between the support post unit and the cantilever for biasing the cantilever to pivot toward a cutter. The feeding wheel unit includes a mounting seat disposed on a free end of the cantilever, and a plurality of feeding wheels disposed rotatably on the mounting seat. A reference line is defined to extend through a contact surface of the fence member and a top surface of the worktable. Outer peripheries of the feeding wheels are spaced apart from the reference line by different distances.

### BACKGROUND OF THE INVENTION

1. Field of the Invention

This invention relates to a woodworking machine, and more particularly to a rotary type feeding device for a woodworking machine that can feed smoothly workpieces of various sizes.

2. Description of the Related Art

The improvement of this invention is directed to a conventional rotary type feeding device for a woodworking machine disclosed in DE102005007955B3. The device has the following disadvantages:

(1) The device is controlled pneumatically. As such, the device is comprised of numerous components, thereby resulting in a complicated structure. Moreover, an expensive air pressure source is required for such pneumatic control.

(2) The device includes a driving mechanism for moving workpieces, which is also complicated in structure and which has a motor. The motor projects outwardly from an outer periphery of a worktable, and is liable to cause a danger to the user.

### SUMMARY OF THE INVENTION

The object of this invention is to provide a rotary type feeding device for a woodworking machine that has a simple structure and that is not controlled pneumatically.

According to this invention, a rotary type feeding device for a woodworking machine includes a support post unit, a cantilever unit, and a feeding wheel unit. The support post unit includes a base fixed on a worktable, and an upright pivot shaft fixed on the base. The cantilever unit includes a cantilever rotatable about the pivot shaft, and a return member disposed between the support post unit and the cantilever for biasing the cantilever to pivot toward a cutter. The feeding wheel unit includes a mounting seat disposed on a free end of the cantilever, and a plurality of feeding wheels disposed rotatably on the mounting seat. A reference line is defined to extend through a contact surface of the fence member and a top surface of the worktable. Outer peripheries of the feeding wheels are spaced apart from the reference line by different distances.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a perspective view of a woodworking machine incorporating the preferred embodiment of a rotary type feeding device according to this invention;

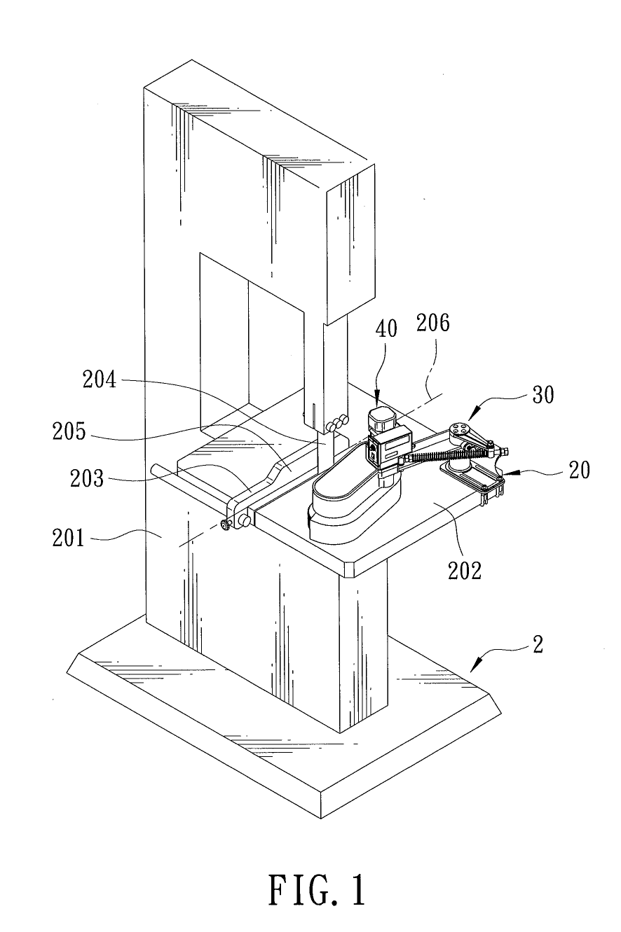

FIG. 2 is a fragmentary perspective view of the preferred embodiment;

FIG. 3 is a partly exploded perspective view of the preferred embodiment;

FIG. 4 is a front view of the preferred embodiment;

FIG. 5 is a side view of the preferred embodiment;

FIG. 6 is a top view of the preferred embodiment, illustrating how a workpiece is brought into contact with a third feeding wheel;

FIG. 7 is a fragmentary sectional view of the preferred embodiment, illustrating a lock pin;

FIG. 8 is a top view of the preferred embodiment, illustrating how the workpiece is moved by the third feeding wheel;

FIG. 9 is a top view of the preferred embodiment, illustrating how the workpiece is moved by a second feeding wheel;

FIG. 10 is a top view of the preferred embodiment, illustrating how the workpiece is moved by a first feeding wheel;

FIG. 11 is a top view of the preferred embodiment, illustrating a cantilever at an open position; and

FIG. 12 is a fragmentary, partly sectional view of the preferred embodiment, illustrating how the cantilever is maintained at the open position by the lock pin.

### DETAILED DESCRIPTION OF THE PREFERRED EMBODIMENT

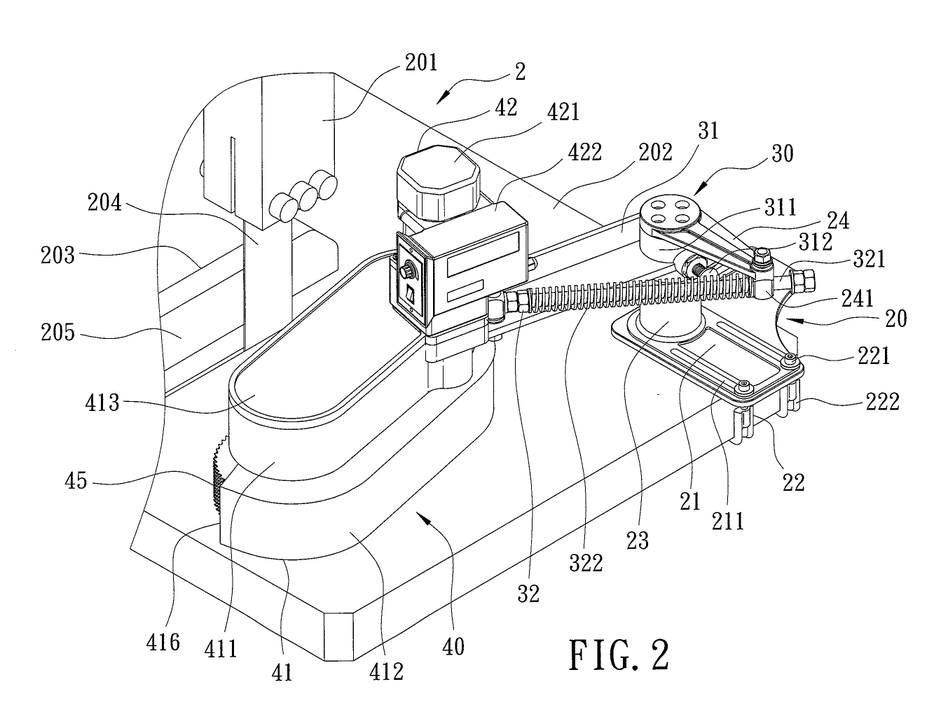

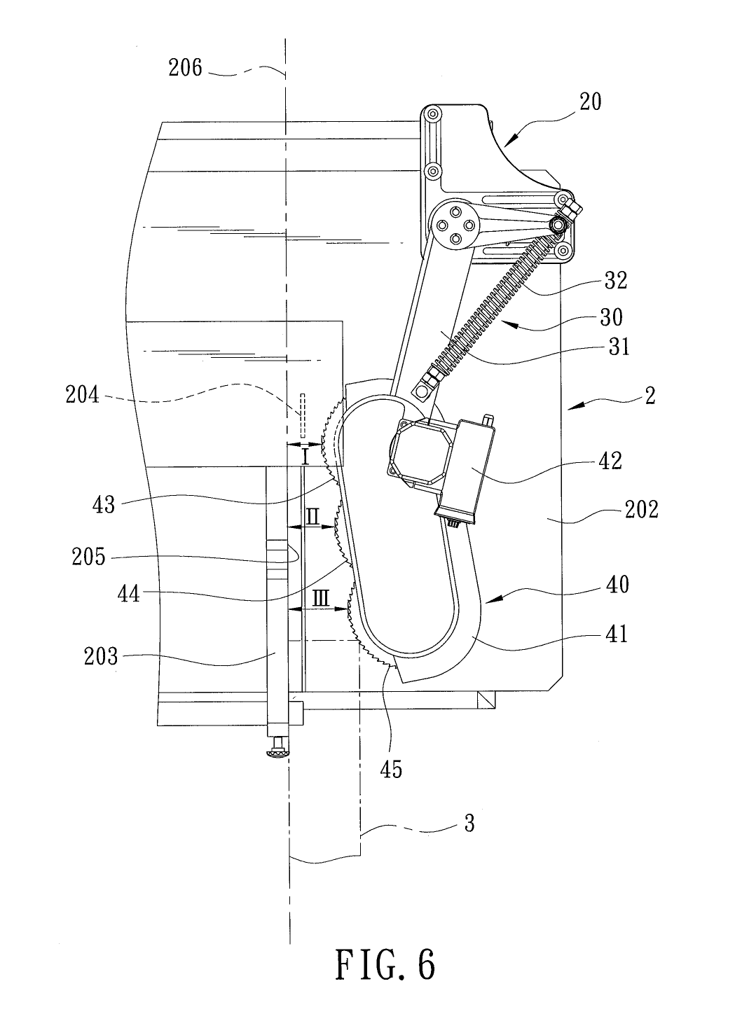

FIG. 2 shows a woodworking machine 2 that incorporates the preferred embodiment of a rotary type feeding device according to this invention. The machine 2 includes machine bed 201, a worktable 202 disposed on the machine bed 201, a fence member 203 disposed on the worktable 202, and a cutter 204 extending through the worktable 202. The fence member 203 has a contact surface 205 facing the cutter 204, and defines a reference line 206 extending through the contact surface 205 and a top surface of the worktable 202. A workpiece 3 (see FIG. 6) can be placed on the worktable 202, and in slidable contact with the contact surface 205 of the fence member 203. A cutting operation can be performed on the workpiece 3 by the cutter 204. The feeding device includes a support post unit 20, a cantilever unit 30, and a feeding wheel unit 40.

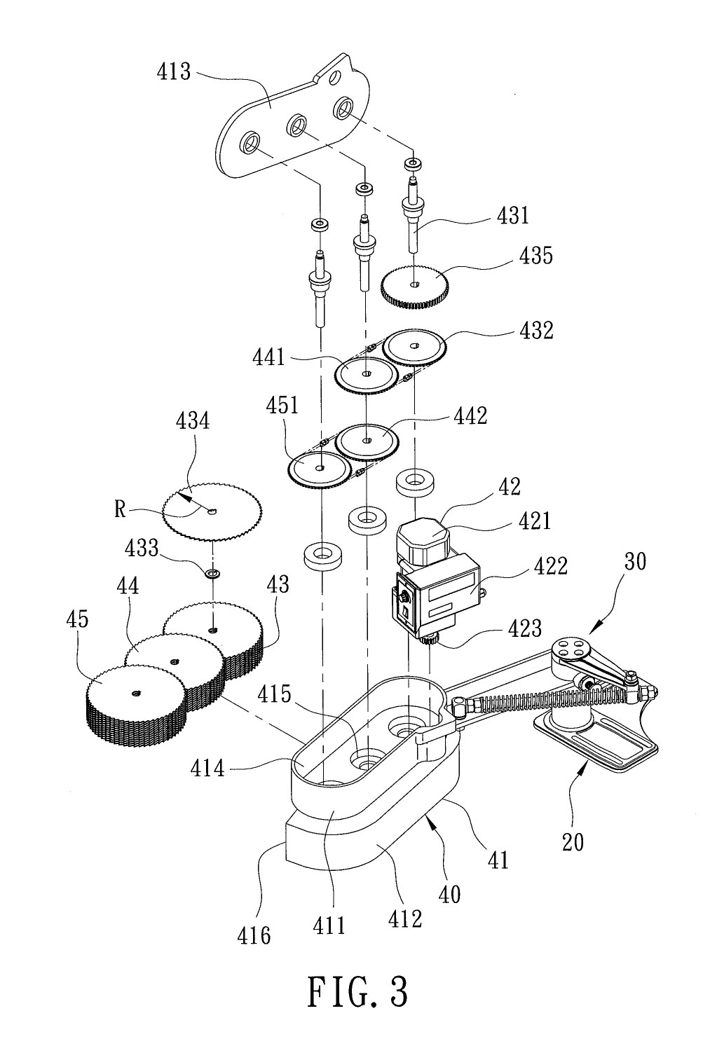

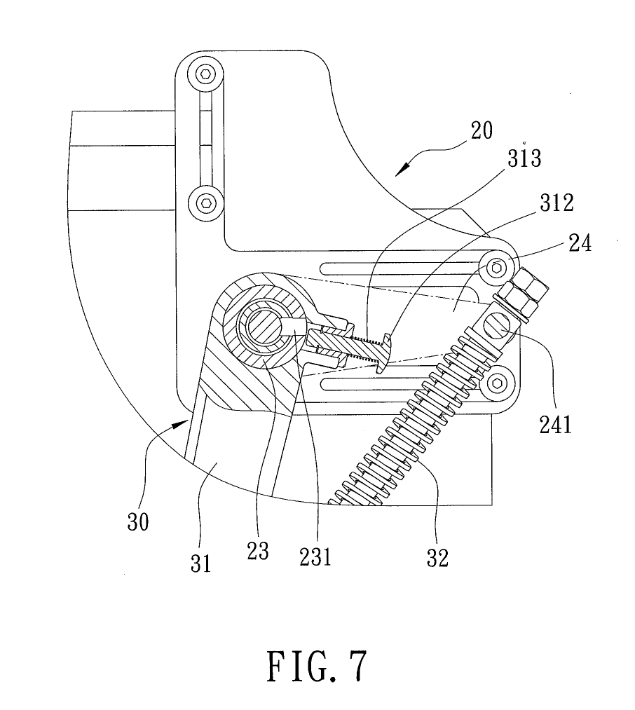

Referring to FIGS. 2 and 3, the support post unit 20 includes a base 21 fixed on the worktable 202, a plurality of clamping members 22 extending through the base 21, an upright pivot shaft 23 fixed on the base 21, and a horizontal extension rod 24 connected fixedly to an upper end of the pivot shaft 23. The base 21 has a plurality of adjustment slots 211 permitting extension of the clamping members 22, respectively. Each of the clamping members 22 includes a headed bolt 221 and a hook 222 that has a lower hook end abutting against a bottom surface of the worktable 202, and an internally threaded upper end engaging the bolt 221 to thereby clamp the worktable 202 between a head of the bolt 221 and the hook 222. As such, the base 21 is fixed on the worktable 202. The pivot shaft 23 has an annular outer surface formed with a positioning hole 231 (see FIG. 7). The extension rod 24 is provided with a rotating block 241 disposed rotatably at an end thereof distal from the pivot shaft 23.

The cantilever unit 30 includes a cantilever 31 rotatable about the pivot shaft 23, and a return member 32 disposed between the support post unit 20 and the cantilever 31 for biasing the cantilever 31 to pivot toward the cutter 204. Referring to FIG. 7, the cantilever 31 includes a pivot ring 311 sleeved rotatably on the pivot shaft 23, a lock pin 312 disposed movably on the pivot ring 311, and a spring 313 sleeved on the lock pin 312 for biasing the lock pin 312 away from the positioning hole 231. Again referring to FIGS. 2 and 3, the return member 32 includes a connecting rod 321 connected pivotally to the cantilever 31 at one end thereof and extending movably through the rotating block 241 at the other end thereof, and a spring 322 sleeved on the connecting rod 321 for biasing the cantilever 31 to pivot toward the cutter 204.

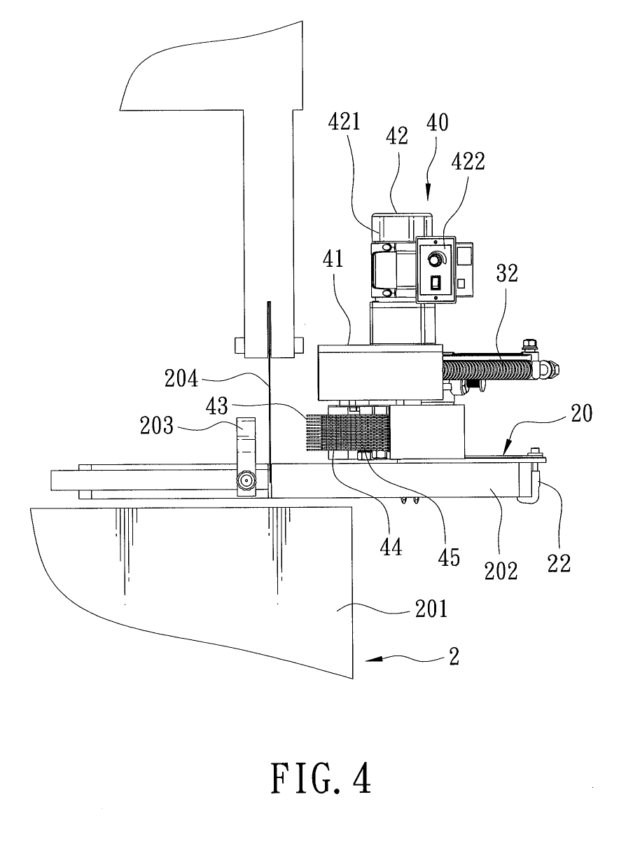

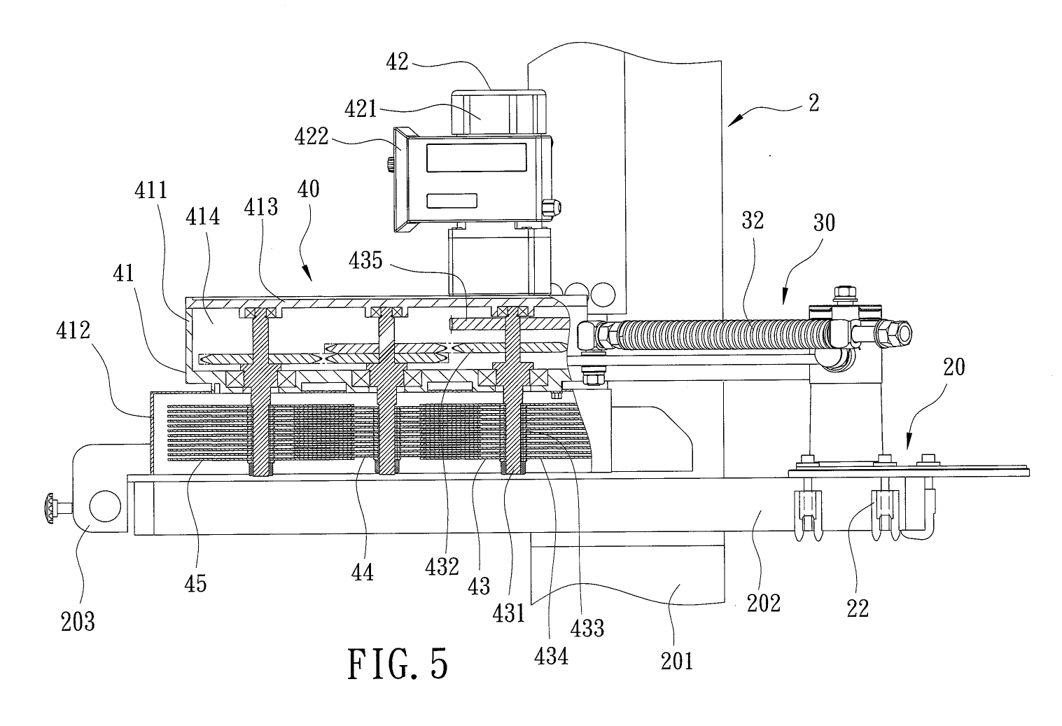

Referring to FIGS. 3 to 6, the feeding wheel unit 40 includes a mounting seat 41 disposed on a free end of the cantilever 31, a driving mechanism 42 disposed in an upper portion of the mounting seat 41, and first, second, and third feeding wheels 43, 44, 45 disposed rotatably in the mounting seat 41. The first feeding wheel 43 is disposed between the second feeding wheel 44 and the pivot shaft 23. The second feeding wheel 44 is disposed between the first and third feeding wheels 43, 45. That is, the third feeding wheel 45 is farther away from the pivot shaft 23 than the second feeding wheel 44. The mounting seat 41 includes an upper seat body 411 defining an accommodating chamber 414, a lower housing 412, and a cover plate 413 covering the accommodating chamber 414. The upper seat body 411 further has a bottom wall formed with three holes 415 extending therethrough. The lower housing 412 has an open side 416 adjacent to and open toward the fence member 203. The driving mechanism 42 includes a motor 421 disposed on the mounting seat 41, and an electric switch 422 disposed adjacent to the motor 421 for controlling operation of the motor 421. The motor 421 has a driving wheel 423 extending into the mounting seat 41. Similar to the second and third feeding wheels 44, 45, the first feeding wheel 43 includes a main shaft 431 disposed rotatably in the corresponding hole 415 in the mounting seat 41, a plurality of spacer rings 433 sleeved on the main shaft 431, and a plurality of ring plates 434 sleeved fixedly on the main shaft 431 and arranged alternately with the spacer rings 433. The first feeding wheel 43 further includes a driven wheel 435 engaging the driving wheel 423 of the motor 421. The second feeding wheel 44 is connected to each of the first and third feeding wheels 43, 45 by a pair of sprockets 432, 441, 442, 451 and a chain. As such, the first, second, and third feeding wheels 43, 44, 45 are driven by the motor 421 at the same speed. Each of the ring plates 434 is disposed in the lower housing 412, and has a portion exposed outwardly from the open side 416, and a plurality of teeth disposed along the whole outer periphery thereof for contact with the workpiece 3. Portions of the ring plates of the second feeding wheels 44 are arranged alternately with and spaced apart from portions of the ring plates 434 of each of the first and third feeding wheels 43, 45. Outer peripheries of the first, second, and third feeding wheels 43, 44, 45 are spaced apart from the reference line 206 by first, second, and third distances (I, II, III), respectively. The second distance (II) is greater than the first distance (I), and smaller than the third distance (III). The ring plates 434 of the first, second, and third feeding wheels 43, 44, 45 have the same radius (R). Each of a difference between the first and second distances (I, II) and a difference between the second and third distances (II, III) is smaller than two thirds of the radius (R). As such, when the workpiece 3 is pushed into contact with any of the first, second, and third feeding wheels 43, 44, 45, it can be moved fully along the reference line 206.

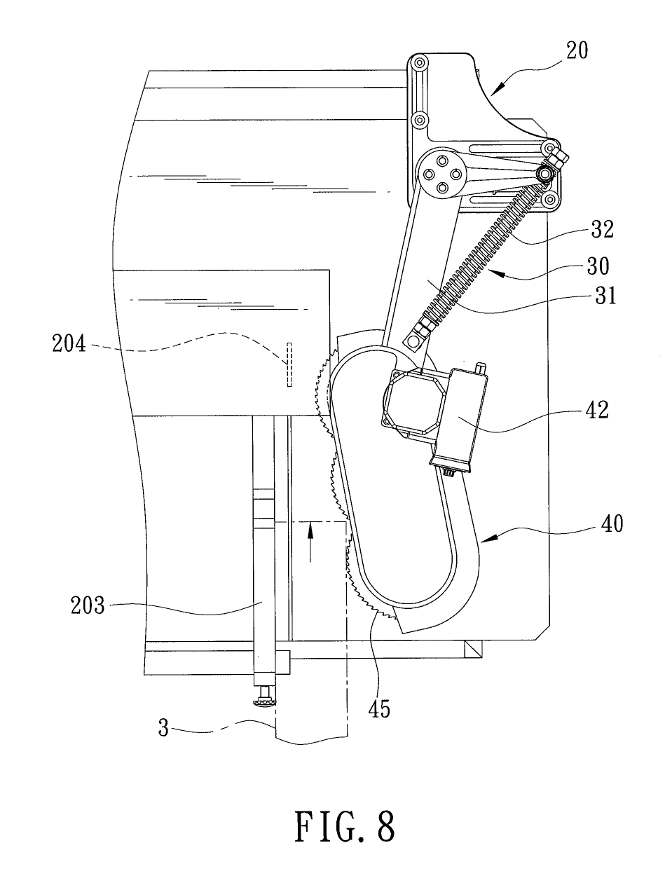

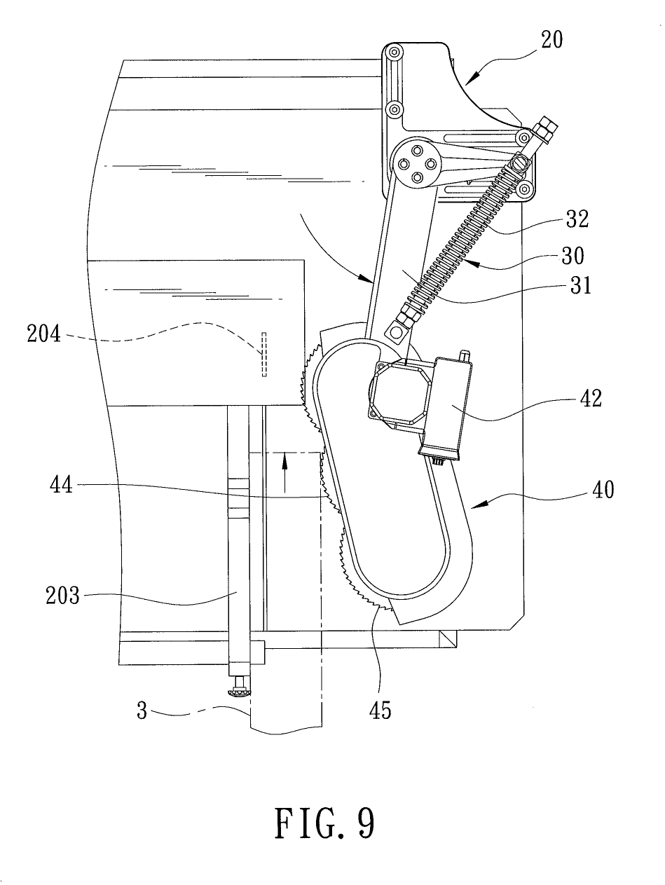

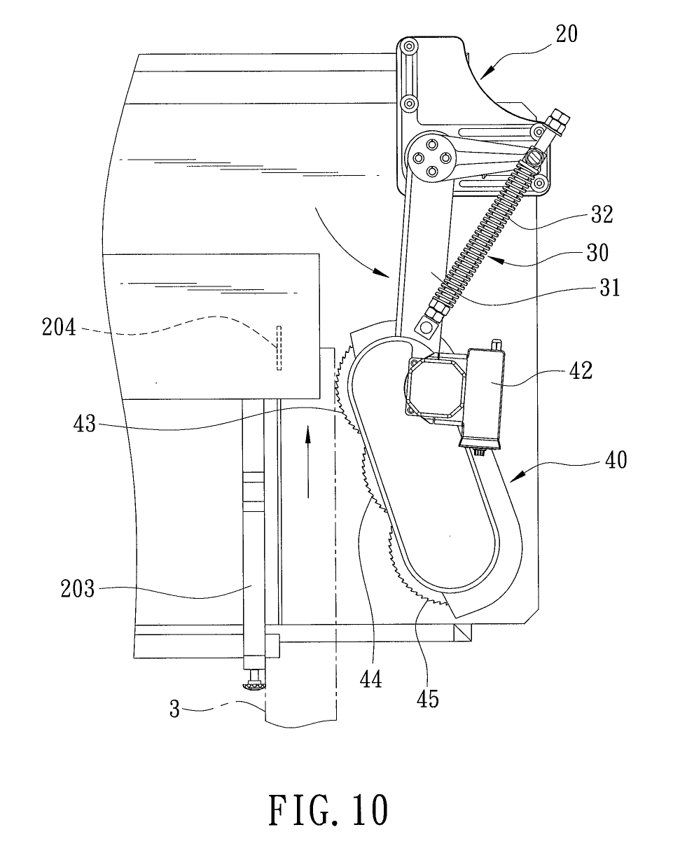

Referring to FIG. 6, when it is desired to cut the workpiece 3, the workpiece 3 is moved into contact with the fence member 203, and is pushed toward the cutter 204. When the workpiece 3 contacts the third feeding wheel 45, the user needs to apply only a relatively small force to the workpiece 3 for pushing the feeding wheel unit 4 away from the fence member 203 to a position shown in FIG. 8. Hence, the workpiece 3 is moved toward the second feeding wheel 44 by the third feeding wheel 45. Subsequently, through operation of the second and first feeding wheels 44, 43, the workpiece 3 is moved toward the cutter 204, as shown in FIGS. 9 and 10, so as to allow for a cutting operation performed thereon by the cutter 204.

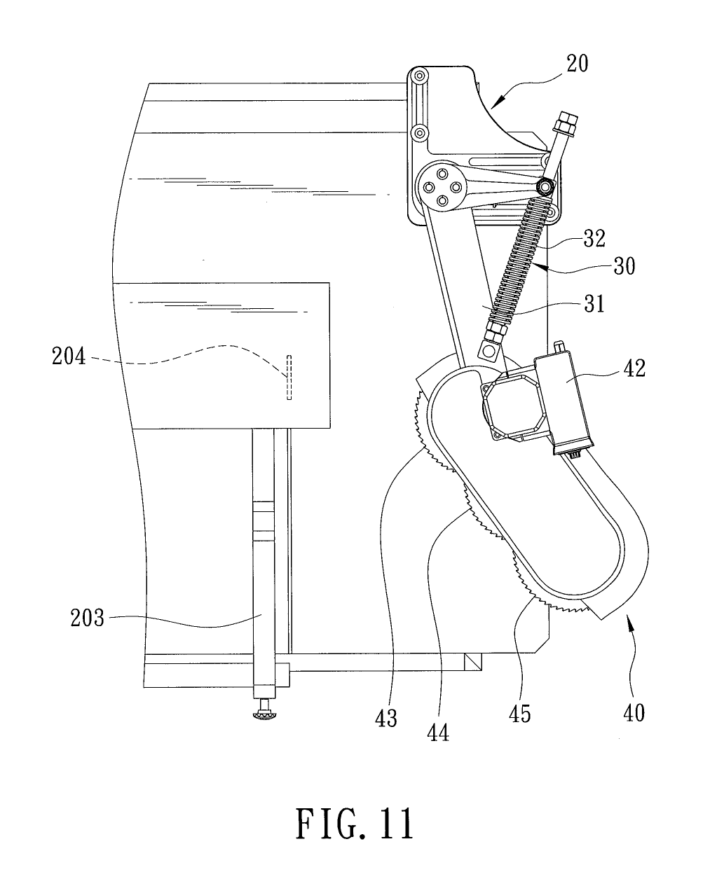

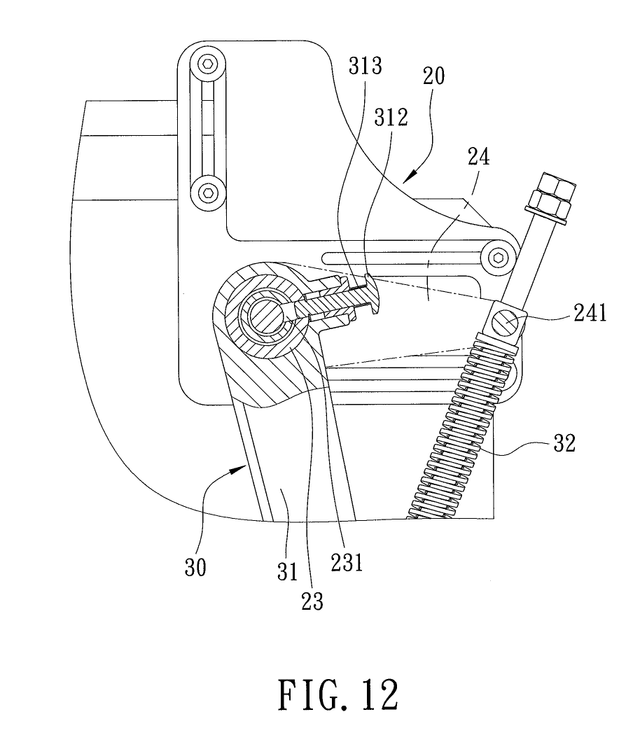

Referring to FIGS. 11 and 12, when replacement of the cutter 204 or a cleaning operation is desired, the cantilever 31 is first pivoted to an open position shown in FIG. 11. Next, the lock pin 242 is pressed into the positioning hole 231 to maintain the cantilever 31 at the open position, thereby facilitating the cutter replacement or cleaning operation.

In view of the above, the feeding device of this invention has a simple structure, and is not controlled pneumatically. Thus, the object of this invention is achieved.

It should be noted that the return member 32 can be replaced by a torsion spring in other preferred embodiments. It should be also noted that, some conventional woodworking machines have fence members provided with power-driven feeding rollers or power-driven caterpillar feeders. If this invention is adapted for use with such a woodworking machine, the driving mechanism 42 can be omitted such that the first, second, and third feeding wheels 43, 44, 45 serve as idle wheels during a workpiece feeding operation.

With this invention thus explained, it is apparent that numerous modifications and variations can be made without departing from the scope and spirit of this invention. It is therefore intended that this invention be limited only as indicated by the appended claims.

I claim:

1. A rotary type feeding device for a woodworking machine, the machine including a machine bed, a worktable disposed on the machine bed, a fence member disposed on the worktable, and a cutter extending through the worktable, the fence member having a contact surface facing the cutter and defining a reference line extending through the contact surface and a top surface of the worktable, said rotary type feeding device comprising:
a support post unit including a base adapted to be fixed on the worktable, and an upright pivot shaft fixed on said base;
a cantilever unit including a cantilever rotatable about said pivot shaft, and a return member disposed between said support post unit and said cantilever and adapted for biasing said cantilever to pivot toward the cutter; and
a feeding wheel unit including a mounting seat disposed on a free end of said cantilever, and a pair of first and second feeding wheels disposed rotatably on said mounting seat, said first feeding wheel being disposed between said second feeding wheel and said pivot shaft and having an outer periphery adapted to be spaced apart from the reference line by a first distance, said second feeding wheel having an outer periphery adapted to be spaced apart from the reference line by a second distance greater than the first distance.

2. The rotary type feeding device as claimed in claim 1, wherein each of said first and second feeding wheels includes a plurality of alternately arranged ring plates and spacer rings, portions of said ring plates of said first feeding wheel being arranged alternately with portions of said ring plates of said second feeding wheel.

3. The rotary type feeding device as claimed in claim 2, wherein said ring plates of said first and second feeding wheels have the same radius, a difference between the first and second distances being smaller than two thirds of the radius.

4. The rotary type feeding device as claimed in claim 1, wherein said feeding wheel unit further includes a third feeding wheel disposed rotatably on said mounting seat and adjacent to said second feeding wheel, said third feeding wheel being farther away from said pivot shaft than said second feeding wheel and having an outer periphery adapted to be spaced apart from the reference line by a third distance greater than the second distance.

5. The rotary type feeding device as claimed in claim 4, wherein each of said first, second, and third feeding wheels includes a plurality of alternately arranged ring plates and spacer rings, portions of said ring plates of said second feeding wheel being arranged alternately with portions of said ring plates of each of said first and third feeding wheels.

6. The rotary type feeding device as claimed in claim 5, wherein said ring plates of said first, second, and third feeding wheels have the same radius, each of a difference between the first and second distances and a difference between the second and third distances being smaller than two thirds of the radius.

7. The rotary type feeding device as claimed in claim 4, wherein said feeding wheel unit includes a motor disposed on said mounting seat and operable for rotating said first, second, and third feeding wheels at the same speed.

8. The rotary type feeding device as claimed in claim 1, wherein said support post unit further includes an extension rod connected fixedly to an upper end of said pivot shaft and provided with a rotating block disposed rotatably at an end thereof distal from said pivot shaft, said return member including a connecting rod connected pivotally to said cantilever at one end thereof and extending movably through said rotating block at the other end thereof, and a spring sleeved on said connecting rod and adapted for biasing said cantilever to pivot toward the cutter.

9. The rotary type feeding device as claimed in claim 8, wherein said pivot shaft has an annular outer surface formed with a positioning hole, said cantilever including a pivot ring sleeved rotatably on said pivot shaft, a lock pin disposed movably on said pivot ring, and a spring for biasing said lock pin away from said positioning hole.
